(19) United States
(12) Patent Application Publication
(10) Pub. No.: US 2019/0064715 A1
(43) Pub. Date: Feb. 28, 2019

(54) IMAGE FORMING APPARATUS HAVING GUIDE PORTIONS ARRANGED IN A DIRECTION CROSSING A TRANSPORTATION DIRECTION OF A RECORDING MEDIUM

(71) Applicant: FUJI XEROX CO., LTD., Tokyo (JP)

(72) Inventor: Keita Hashimoto, Kanagawa (JP)

(73) Assignee: FUJI XEROX CO., LTD., Tokyo (JP)

(21) Appl. No.: 15/945,796

(22) Filed: Apr. 5, 2018

(30) Foreign Application Priority Data
Aug. 30, 2017 (JP) 2017-165042

(51) Int. Cl. G03G 15/20; B65H 29/52

(52) U.S. Cl. CPC G03G 15/2064; B65H 29/52; G03G 15/2053

(57) ABSTRACT

An image forming apparatus includes a fixing device including a pressing unit and a heating unit that opposes the pressing unit; and plural guide portions disposed downstream of the fixing device and arranged in a direction crossing a transporting direction of a recording medium. An amount of projection of the guide portions is smaller in a region near a center of the fixing device than in a region near an end of the fixing device.

### CROSS-REFERENCE TO RELATED APPLICATIONS

This application is based on and claims priority under 35 USC 119 from Japanese Patent Application No. 2017-165042 filed Aug. 30, 2017.

### BACKGROUND

### Technical Field

The present invention relates to an image forming apparatus.

### SUMMARY

According to an aspect of the invention, there is provided an image forming apparatus including a fixing device including a pressing unit and a heating unit that opposes the pressing unit, and plural guide portions disposed downstream of the fixing device and arranged in a direction crossing a transporting direction of a recording medium. An amount of projection of the guide portions is smaller in a region near a center of the fixing device than in a region near an end of the fixing device.

### BRIEF DESCRIPTION OF THE DRAWINGS

Exemplary embodiments of the present invention will be described in detail based on the following figures, wherein:

FIG. 1 is a side sectional view of an image forming apparatus according to first to third exemplary embodiments;

FIG. 2 is a side sectional view of a fixing device and an exit unit according to the first to third exemplary embodiments;

FIG. 3 is a sectional perspective view of a fixing device and an exit unit according to the first exemplary embodiment taken substantially through the center;

FIG. 4A is a sectional view of the fixing device and the exit unit taken substantially through the center, and

FIG. 4B is a sectional view of the fixing device and the exit unit taken along a plane near a second end;

FIG. 5A is a front view of the exit unit according to the first exemplary embodiment, FIG. 5B is a front view of the exit unit according to the first exemplary embodiment illustrating the manner in which a recording medium is transported by the exit unit, and FIG. 5C is a front view corresponding to FIG. 5B, illustrating the exit unit according to the first exemplary embodiment having another shape;

FIGS. 6A and 6B are front views corresponding to FIGS. 5A and 5B, respectively, illustrating an exit unit according to a first modification of the first exemplary embodiment, FIG. 6C is an enlarged view of a guide portion near the center, and FIG. 6D an enlarged view of a guide portion near an end;

FIG. 7 is a sectional perspective view of a fixing device and an exit unit according to the second exemplary embodiment;

FIG. 8A is a front view of the exit unit according to the second exemplary embodiment, and FIG. 8B is a front view of the exit unit according to the second exemplary embodiment illustrating the manner in which a recording medium is transported by the exit unit; and

FIG. 9A is a front view corresponding to FIG. 5A, illustrating an exit unit according to the third exemplary embodiment, and FIG. 9B is a front view of the exit unit according to the third exemplary embodiment illustrating the manner in which a recording medium is transported by the exit unit.

### DETAILED DESCRIPTION

Exemplary embodiments of the present invention will now be described with reference to the drawings. Image forming apparatuses according to the exemplary embodiments described below are merely examples in which the technical idea of the present invention is embodied, and are not intended to limit the present invention. The present invention may be similarly applied to other exemplary embodiments within the scope of the claims.

### First Exemplary Embodiment

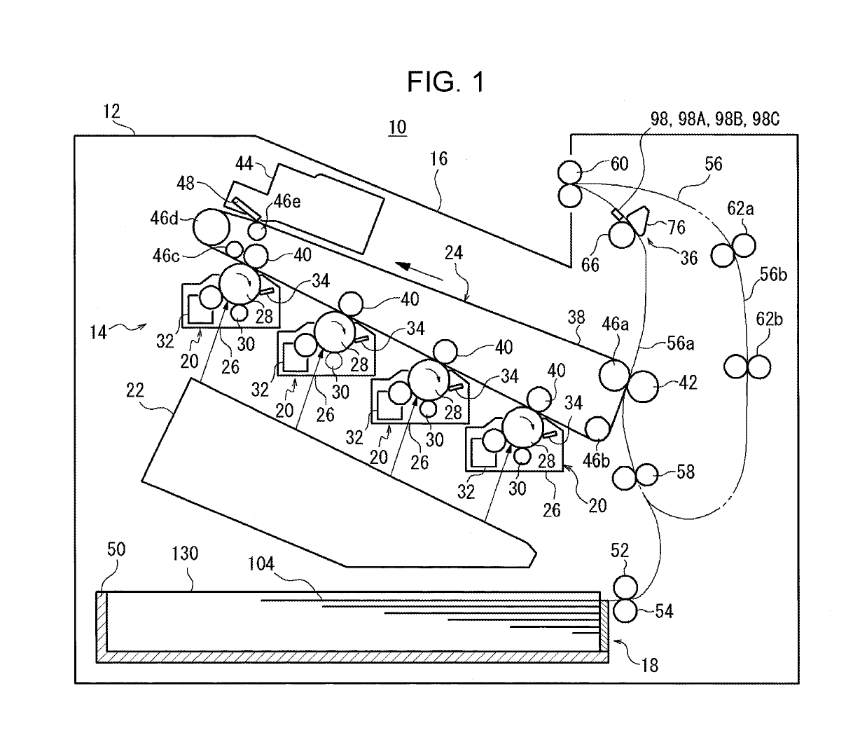

An image forming apparatus 10 according to a first exemplary embodiment will be described with reference to FIGS. 1 to 4B. As illustrated in FIG. 1, the image forming apparatus 10 according to the first exemplary embodiment includes an image forming apparatus body 12. A recording-medium supplying device 18, an image forming device 14, and a fixing device 36 are mounted in the image forming apparatus body 12. The recording-medium supplying device 18 supplies a recording medium 104, such as a recording paper sheet, which serves as a transfer material. The image forming device 14 forms an image to be transferred onto the recording medium 104. A discharge tray 16 to which the recording medium 104 is discharged is provided at the top of the image forming apparatus body 12. A transport path 56 along which the recording medium 104 is transported is arranged to extend through the above-mentioned components. The structure of each component will now be described.

The recording-medium supplying device 18 includes a recording-medium container 50 that contains a stack of recording media 104; a transport roller 52 that extracts the top recording medium 104 of the stack contained in the recording-medium container 50 and transports the extracted recording medium 104 toward the image forming device 14; and a retard roller 54 that separates the recording media 104 from each other to prevent the recording media 104 from being transported to the image forming device 14 in a stacked state.

The image forming device 14 includes, for example, four image forming units 20 corresponding to four colors, which are yellow (Y), magenta (M), cyan (C), and black (K); an optical writing device 22; and a transfer device 24. The image forming units 20 and components thereof have the same structures except for the color of the images formed thereby.

Each image forming unit 20 is a replaceable member that is removably attached to the image forming apparatus body 12. The image forming units 20 for Y, M, C, and K are arranged in that order from the back (right in FIG. 1) of the image forming apparatus body 12.

The image forming units 20 constitute, for example, an electrophotographic system that forms a color image. Each image forming unit 20 includes an image forming unit body 26, in which an image carrier 28, a charging device 30, a developing device 32, and a cleaning device 34 are provided. The image carrier 28 is drum-shaped and carries a developer image. The charging device 30 serves as a charging unit and includes a charging roller that uniformly charges the image carrier 28. The developing device 32 develops a latent image formed on the image carrier 28 by using developer (toner). The cleaning device 34 cleans the image carrier 28 by scraping off waste developer that remains on the image carrier 28.

The developing device 32 develops the latent image formed on the image carrier 28 by using Y, M, C, or K developer contained therein.

The optical writing device 22 serves as a latent-image forming device, and is composed of, for example, a laser scanning exposure device. The optical writing device 22 forms a latent image on the surface of each image carrier 28. Other examples of the optical writing device 22 include an LED and a surface emitting laser.

The transfer device 24 includes a transfer member 38 that serves as a transfer body, first transfer rollers 40 that serve as first transfer devices, a second transfer roller 42 that serves as a second transfer device, and a cleaning device 44.

The transfer member 38 is, for example, endless-belt-shaped, and is supported by five support rollers 46a, 46b, 46c, 46d, and 46e such that the transfer member 38 is rotatable in the direction shown by the arrow in FIG. 1. At least one of the support rollers 46a, 46b, 46c, 46d, and 46e is connected to a power source (not shown), such as a motor, and rotates upon receiving a driving force from the power source, so that the transfer member 38 is rotated.

The support roller 46a is arranged to oppose the second transfer roller 42, and functions as a back-up roller for the second transfer roller 42. A position between the second transfer roller 42 and the support roller 46a serves as a second transfer position.

Each first transfer roller 40 transfers the developer image formed on the surface of the corresponding image carrier 28 by the corresponding developing device 32 onto the transfer member 38.

The second transfer roller 42 transfers the Y, M, C, and K developer images that have been transferred to the transfer member 38 onto the recording medium 104.

The cleaning device 44 includes a scraping member 48 that scrapes off the developers of the respective colors that remain on the surface of the transfer member 38 after the developer images of the respective colors have been transferred to the recording medium 104 by the second transfer roller 42. The developers that have been scraped off by the scraping member 48 are collected in the cleaning device 44.

The transport path 56 includes a first transport path 56a and a second transport path 56b.

The first transport path 56a allows the recording medium 104 supplied from the recording-medium supplying device 18 to be transported to the image forming device 14, and then be discharged to the discharge tray 16 after an image is formed thereon. The transport roller 52, the retard roller 54, registration rollers 58, the transfer device 24, the fixing device 36, and discharge rollers 60, which serve as a discharge unit, are arranged along the first transport path 56a in that order from the upstream side in a transporting direction in which the recording medium 104 is transported.

The registration rollers 58 temporarily stop the leading end of the recording medium 104 that has been transported from the recording-medium supplying device 18, and then transports the recording medium 104 toward the transfer device 24 at a time that matches the time at which the image is formed.

The fixing device 36 includes a heating roller 66 that serves as a heating unit and a pressing unit 76 that opposes the heating roller 66. The heating roller 66 and the pressing unit 76 heat and press the recording medium 104 that passes therebetween, so that the developer image is fixed to the recording medium 104. The fixing device 36 will be described in detail below.

The discharge rollers 60 discharge the recording medium 104 to the discharge tray 16 after the developers are fixed to the recording medium 104 by the fixing device 36.

The second transport path 56b reverses the recording medium 104 having the developer image formed on one side thereof, and supplies the recording medium 104 to the image forming device 14 again. Two pairs of reversing transport rollers 62a and 62b, for example, are arranged along the second transport path 56b.

After the recording medium 104 is transported from the first transport path 56a to the discharge rollers 60, the discharge rollers 60 are rotated in the reverse direction while the trailing end portion of the recording medium 104 is nipped therebetween, so that the recording medium 104 is supplied to the second transport path 56b. The recording medium 104 that has been supplied to the second transport path 56b is transported to a location upstream of the registration rollers 58 by the reverse transport rollers 62a and 62b.

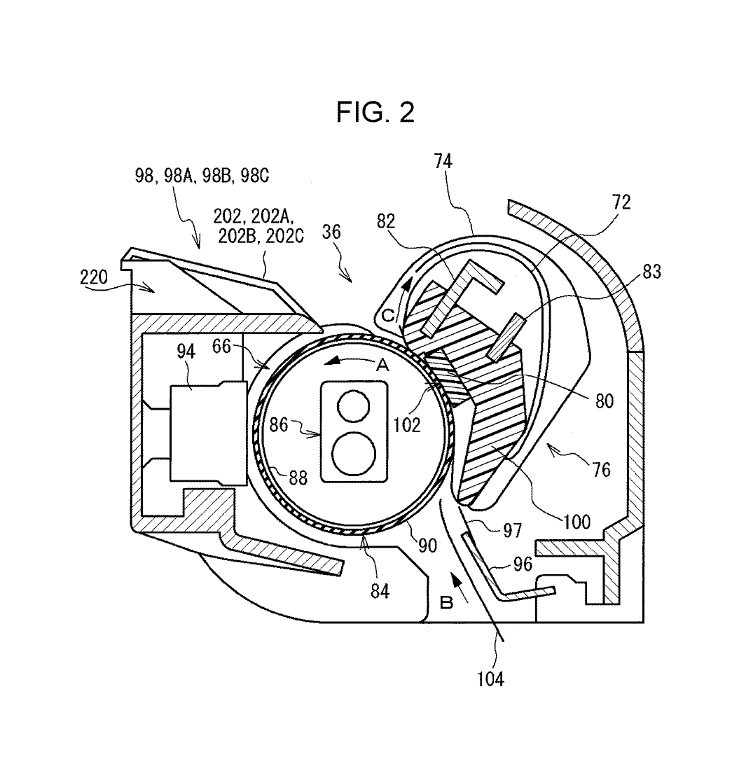

The fixing device 36 according to the first exemplary embodiment will now be described. As illustrated in FIGS. 2 to 5C, the fixing device 36 includes the heating roller 66; an endless belt 72 that serves as an endless band-shaped member; guide members 74 that guide the endless belt 72 in a rotatable manner; and the pressing unit 76. The pressing unit 76 is disposed inside the endless belt 72 and pressed against the heating roller 66 together with the endless belt 72. A releasing member, for example, for releasing the recording medium 104 that is transported may be disposed downstream of the fixing device 36.

The heating roller 66 includes a cylindrical roller portion 84 and a heater 86 disposed in the roller portion 84. The roller portion 84 is rotatably supported by heating roller bearings (not shown), and rotates in the direction of arrow A (see FIG. 2). The roller portion 84 is, for example, a so-called hard roller and includes a core 88 made of a metal material, such as iron, stainless steel, or aluminum, and a releasing layer 90 formed on or applied to the core 88. The releasing layer 90 is made of an insulating material having high releasability, such as PFA.

The heater 86 includes, for example, two lamps. A thermostat 94 is arranged to oppose the heating roller 66 at a side opposite to the side at which the endless belt 72 is disposed.

The roller portion 84 is not limited to the above-described hard roller, and may instead be a soft roller including an elastic layer on the core thereof.

The endless belt 72 is disposed between the heating roller 66 and the pressing unit 76, and is moved in the direction of arrow C (see FIG. 2) by the rotation of the heating roller 66. The heating roller 66 and the endless belt 72 are pressed against each other by the pressing unit 76, so that a pressing region 102 is formed therebetween. The toner image is fixed to the recording medium 104 in the pressing region 102. The endless belt 72 is obtained by forming a synthetic resin, such as polyimide, into an endless belt shape.

An entrance unit 96, which guides the transported recording medium 104 to the fixing device 36, is disposed upstream of the fixing device 36, more specifically, upstream of the pressing region 102. The entrance unit 96 guides the recording medium 104 transported in the direction of arrow B so that the leading end of the recording medium 104 moves toward the pressing region 102 (see FIG. 2). An entrance blocking member 97 is provided in the gap between the entrance unit 96 and the pressing unit 76 to prevent entrance of the recording medium 104 through the gap.

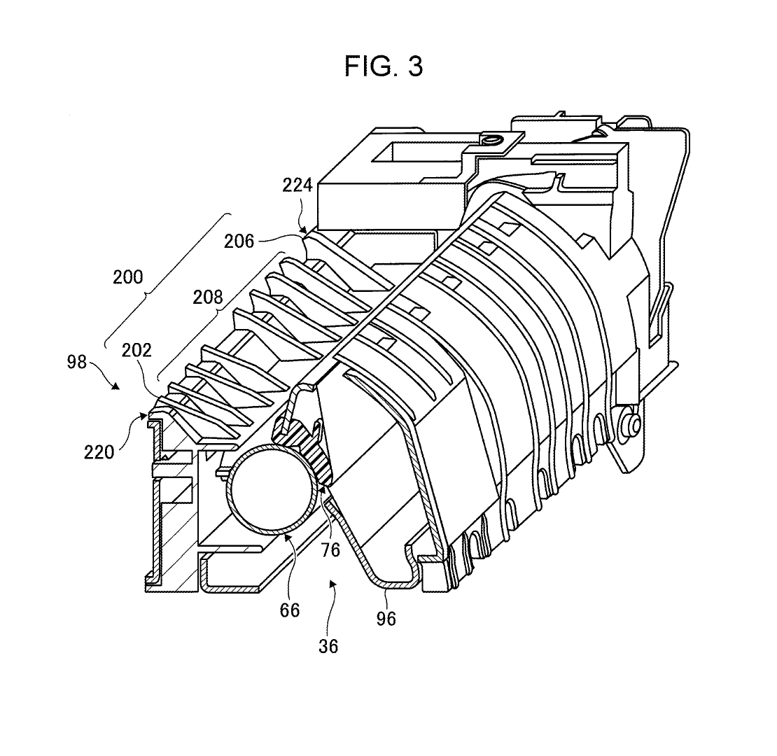

As illustrated in FIGS. 3 to 5C, plural guide portions 200 for guiding the recording medium 104 to the discharge rollers 60 are disposed downstream of the fixing device 36, more specifically, downstream of the pressing region 102. In the first exemplary embodiment, the guide portions 200 are formed on an exit unit 98, which is provided downstream of the fixing device 36.

In the first exemplary embodiment, the exit unit 98, on which the guide portions 200 are formed, is provided between the fixing device 36 and the discharge rollers 60. More specifically, the exit unit 98 is provided downstream of the fixing device 36 and upstream of the discharge rollers 60, which discharge the recording medium 104 to the discharge tray 16. In the case where no discharge rollers are provided, the exit unit 98 is provided upstream of a mechanism such as a discharge hole through which the recording medium is discharged.

As illustrated in FIG. 2, the pressing unit 76 includes a holder 100 disposed inside the endless belt 72, an elastic member 80 provided on the holder 100, and frames 82 and 83 that support the holder 100. A sliding member for reducing friction may be provided between the endless belt 72 and the holder 100. The holder 100 is made of a resin material, for example, liquid crystal polymer (LCP), which is highly heat-resistant. The elastic member 80 is substantially as long as the holder 100 in the longitudinal direction, and is obtained by forming a heat-resistant resin material, such as silicon rubber, into a substantially rectangular parallelepiped shape.

Referring to FIG. 2, the guide members 74 are provided at respective ends of the endless belt 72 and the pressing unit 76. The pressing unit 76 is supported by the guide members 74.

Referring to FIG. 2, the frames 82 and 83 support the holder 100, and are supported by the guide members 74 at both ends thereof so that the holder 100 is pressed against the heating roller 66. Both end portions of each of the frames 82 and 83 extend through the guide members 74, and are urged toward the heating roller 66 by urging units, such as springs (not shown).

The exit unit 98 and the guide portions 200 formed on the exit unit 98 will now be described with reference to FIGS. 2 to 5C. As illustrated in FIGS. 2 to 4B, the exit unit 98 is provided downstream of the fixing device 36, and the guide portions 200 are formed thereon. The recording medium 104 to which toner is fixed is discharged from the fixing device 36, transported along the guide portions 200 on the exit unit 98, and guided to the discharge rollers 60.

In the first exemplary embodiment, the recording medium 104 is transported in such a manner that the side on which the image is formed faces the guide portions 200.

The exit unit 98 is composed of a block having a predetermined width, for example, a width substantially equal to that of the heating roller 66 of the fixing device 36 in the width direction (direction crossing the transporting direction) and a predetermined length in the transporting direction. The exit unit 98 may be integrated with the fixing device 36 or be formed as a separate component that is attached to the image forming apparatus body 12 at a location between the fixing device 36 and the discharge rollers 60.

The guide portions 200 are plate-shaped members that substantially perpendicularly project from the exit unit 98 at a side along which the recording medium 104 is transported. The guide portions 200 have a predetermined length in the transporting direction of the recording medium 104. Thus, the guide portions 200 formed on the exit unit 98 have a predetermined length in the direction from the fixing device 36 toward the discharge rollers 60.

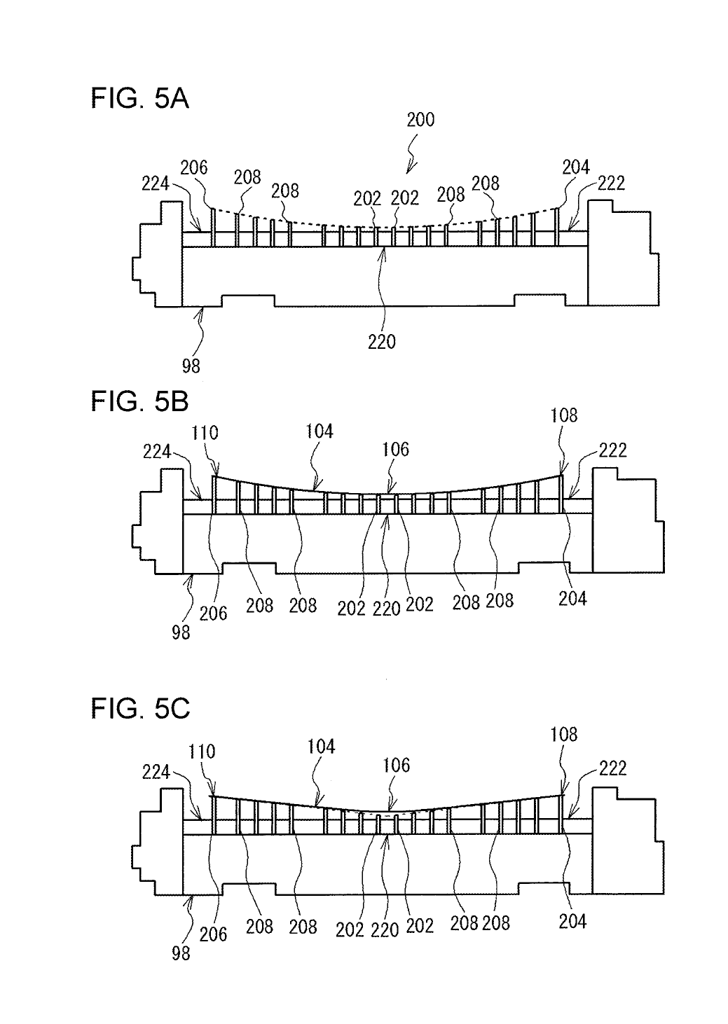

As illustrated in FIG. 5A, the guide portions 200 on the exit unit 98, which is disposed downstream of the fixing device 36, are arranged with predetermined gaps therebetween in the direction crossing the transporting direction of the recording medium 104 (width direction). In the first exemplary embodiment, eighteen guide portions 200 are arranged substantially symmetrically about a center 220 of the exit unit 98.

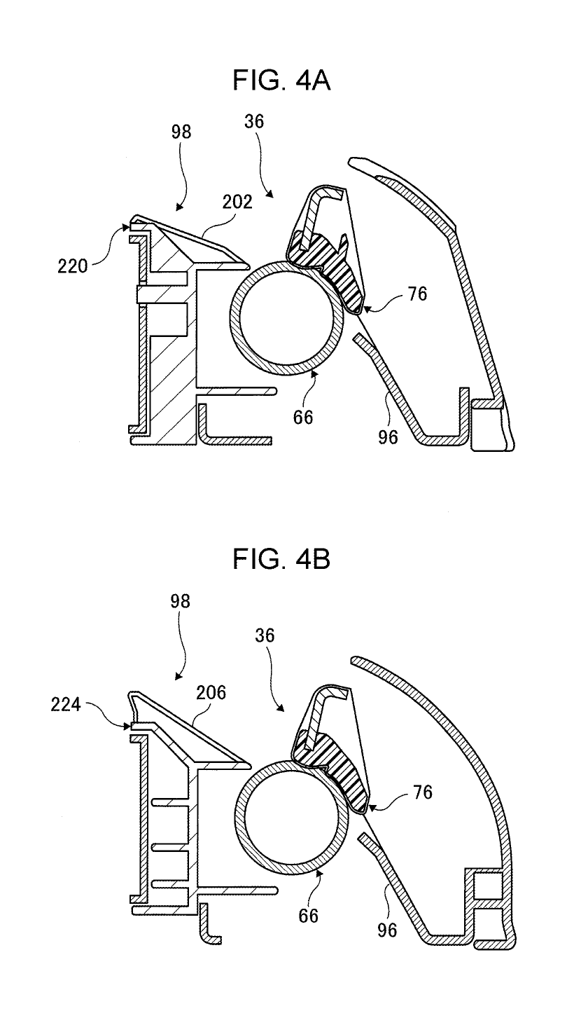

The guide portions 200 are arranged so as to project toward the transported recording medium 104 by different amounts depending on the positions of portions of the recording medium that pass thereby. More specifically, in the first exemplary embodiment, as illustrated in FIGS. 4A, 4B, and 5A, the guide portions 200 include guide portions 202 near the center 220 of the exit unit 98 in the direction crossing the transporting direction, more specifically, at a position where a substantially central portion 106 of the recording medium 104 in the direction crossing the transporting direction passes. The guide portions 202 have a smallest amount of projection that is smaller than amounts of projection of guide portions 204 and 206 near both ends 222 and 224, which will be described below, and other guide portions 208. Here, the other guide portions 208 are guide portions other than the guide portions 202 near the center 220 and the guide portions 204 and 206 near both ends 222 and 224. Although a pair of guide portions 202 are arranged symmetrically about the center 220 as the guide portions 202 near the center 220 in the first exemplary embodiment, a single guide portion 202 may instead be provided at the center 220.

The guide portions 204 and 206 are respectively formed near a first end 222 and a second end 224 (hereinafter sometimes referred to simply as both ends 222 and 224) of the exit unit 98 in the width direction, more specifically, at positions where a first end portion 108 and a second end portion 110 (hereinafter sometimes referred to simply as both end portions 108 and 110) of the recording medium 104 in the direction crossing the transporting direction pass. The guide portion 204 near the first end 222 and the guide portion 206 near the second end 224 (hereinafter sometimes referred to simply as the guide portions 204 and 206 near both ends 222 and 224) project by an amount larger than the amounts of projection of the guide portions 202 near the center 220 and the other guide portions 208. In other words, the guide portions 204 and 206 near both ends 222 and 224 of the exit unit 98 have a largest amount of projection, which is larger than the amounts of projection of the guide portions 202 near the center 220 and the other guide portions 208.

The guide portions 200 according to the first exemplary embodiment are formed so that the amount of projection thereof gradually decreases from the guide portions 204 and 206 near both ends 222 and 224 toward the guide portions 202 near the center 220. More specifically, in the first exemplary embodiment, the guide portions 200 are formed so that the guide portions 202 near the center 220 have a smallest amount of projection and that the amount of projection gradually increases toward both ends 222 and 224 so as to form a curved or substantially curved bowl shape.

The recording medium 104 is discharged from the fixing device 36 after being heated and pressed by the heating roller 66 and the pressing unit 76 of the fixing device 36. Accordingly, the discharged recording medium 104 is curved as illustrated in FIG. 5B, that is, such that the central portion 106 thereof in the direction crossing the transporting direction of recording medium 104 is warped toward the guide portions 200 with respect to both end portions 108 and 110.

If the guide portions are formed so as to project by the same amount, a portion of the recording medium 104, in particular, a central portion of the recording medium 104 receives a large contact force from the guide portions, and there is a risk that defects such as streaks will be formed on the image due to the guide portions immediately after the image is fixed.

In contrast, in the first exemplary embodiment, the guide portions 200 on the exit unit 98 are formed so that the amount of projection of the guide portions 202 near the center 220 is smaller than that of the guide portions 204 and 206 near both ends 222 and 224. Accordingly, as illustrated in FIG. 5B, the recording medium 104 discharged from the fixing device 36 in a curved state also comes into contact with the guide portions 204 and 206 near both ends 222 and 224. As a result, the risk that only the central portion 106 of the recording medium 104 will receive a large contact force and that defects such as streaks will be formed on the image due to the guide portions may be reduced.

When the guide portions 200 are formed so that parts thereof near the discharge rollers 60 are flat, the curved recording medium 104 may be substantially flattened when the recording medium 104 is transported along the flat parts of the guide portions 200.

Alternatively, a device for flattening the curved recording medium may be provided between the exit unit 98 and the discharge rollers. Alternatively, the curved recording medium may be flattened by the discharge rollers.

In the first exemplary embodiment, the recording medium 104 is transported while the side on which the image is formed faces the guide portions 200. However, the recording medium 104 may instead be transported while the side opposite to the side on which the image is formed faces the guide portions 200.

As illustrated in FIG. 5C, the guide portions 200 may instead be formed so that the guide portions 202 near the center 220 have a smallest amount of projection, that the guide portions 204 and 206 near both ends 222 and 224 have a largest amount of projection, and that the amount of projection of the guide portions 200 substantially linearly increases from the guide portions 202 near the center 220 toward the guide portions 204 and 206 near both ends 222 and 224. In other words, the guide portions 200 may be arranged so as to form a V-shape.

### First Modification

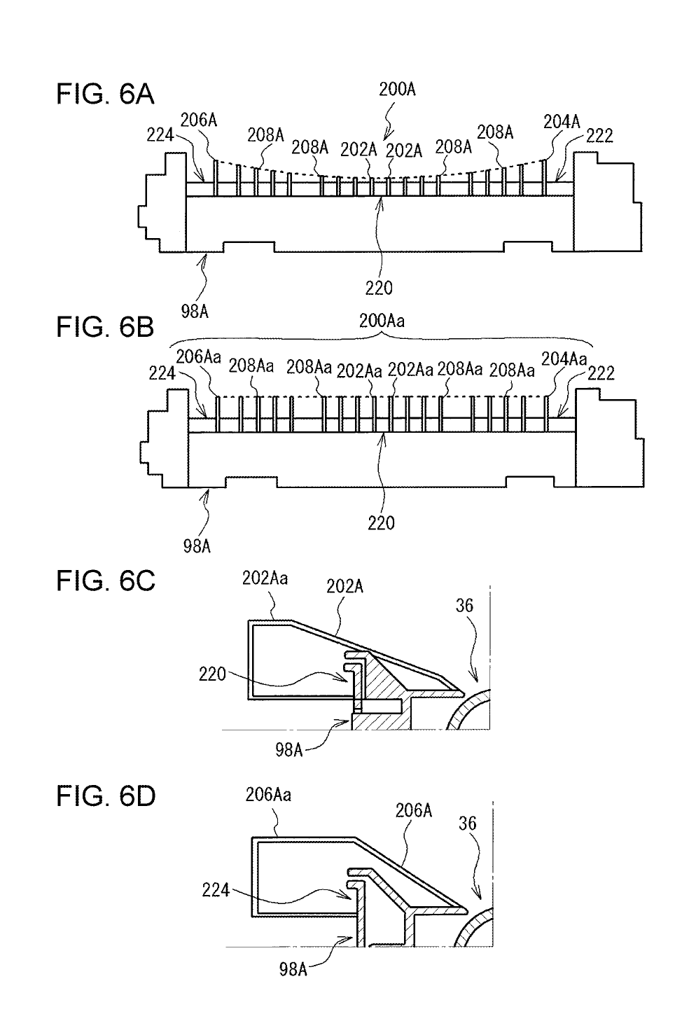

The guide portions 200 of the first exemplary embodiment extend substantially linearly in the transporting direction and are formed so that the guide portions 202 near the center 220 have a smallest amount of projection and that the amount of projection gradually increases toward the guide portions 204 and 206 near both ends 222 and 224. However, the guide portions are not limited to this. As in a first modification illustrated in FIG. 6, guide portions 200A may be formed so that parts thereof near the fixing device 36 have different amounts of projection but parts thereof near the discharge rollers 60 are formed as flat parts 200Aa (202Aa, 204Aa, 206Aa, and 208Aa) that project so as to form a substantially flat shape. Here, the phrase “substantially flat” means that the difference in the amount of projection between the guide portions near both ends and the guide portions near the center is small, and it is not necessary that all the guide portions have the same amount of projection.

More specifically, according to the first modification, in a region near the fixing device 36, the guide portions 200A on an exit unit 98A are formed so that guide portions 202A near the center 220 have a smallest amount of projection and that guide portions 204A and 206A near both ends 222 and 224 have an amount of projection larger than that of the guide portions 202A near the center 220 (see FIGS. 6A, 6C, and 6D). However, as the distance from the fixing device 36 increases, the amount of projection of the guide portions 202A near the center 220 and the amount of projection of the guide portions 204A and 206A near both ends 222 and 224 become closer to each other and the difference therebetween decreases. In a region near the discharge rollers 60, the guide portions 202A near the center 220 and the guide portions 204A and 206A near both ends 222 and 224 have substantially the same amount of projection (see FIGS. 6B, 6C, and 6D).

Other guide portions 208A, which are disposed between the guide portions 202A near the center 220 and the guide portions 204A and 206A near both ends 222 and 224, are also formed so that they have different amounts of projection in the region near the fixing device 36 and that as the distance from the fixing device 36 increases, the guide portions 200A project by amounts with smaller differences to form a substantially flat shape.

In the first modification, parts of the guide portions 200A near the discharge rollers 60 are formed as the flat parts 200Aa that project by substantially the same amount to form a substantially flat shape. The flat parts 200Aa include flat parts 202Aa of the guide portions 202A near the center 220, flat parts 204Aa and 206Aa of the guide portions 204A and 206A near both ends 222 and 224, and flat parts 208Aa of the other guide portions 208A, and have substantially the same amount of projection (see FIGS. 6B, 6C, and 6D).

In the first modification, the guide portions 200A are formed so that the amount of projection of the flat parts 200Aa near the discharge rollers 60 is equal to the amount of projection of the guide portions 204A and 206A near both ends 222 and 224. With this structure, the curved recording medium 104 may be substantially flattened by transporting the recording medium 104 along the guide portions 200A.

In the first modification, the guide portions 200A are formed so that the difference in the amount of projection gradually decreases with increasing distance toward the downstream side of the exit unit 98. However, the guide portions are not limited to this, and may instead be formed so that parts thereof that are closer to the discharge rollers 60 than a predetermined point on a downstream section of the exit unit in the transporting direction of the recording medium 104 form a substantially flat shape. In this case, it is not necessary that the amount of projection of the guide portions be substantially equal to that of the guide portions near both ends, and may be any amount according to the design.

### Second Exemplary Embodiment

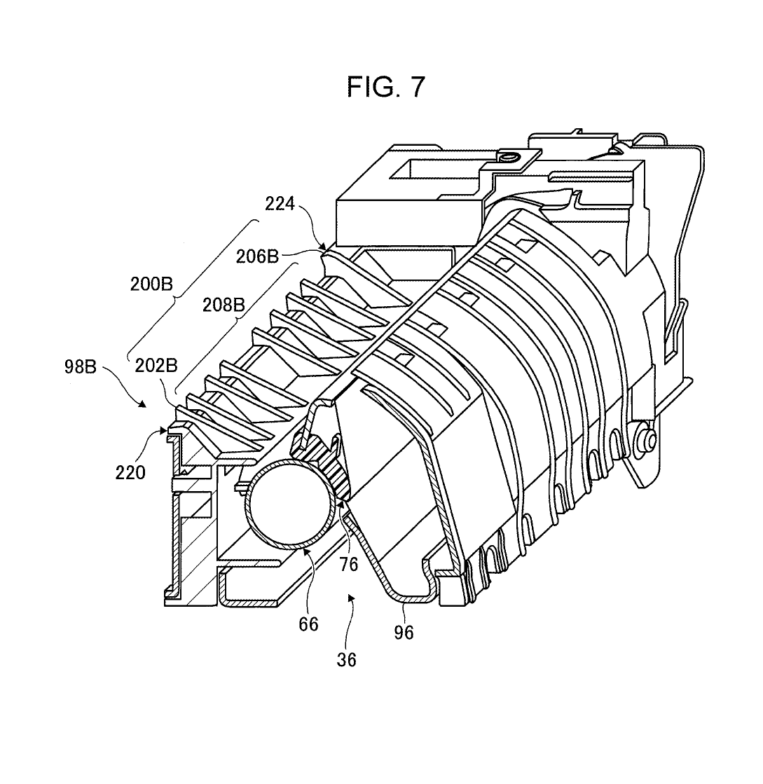

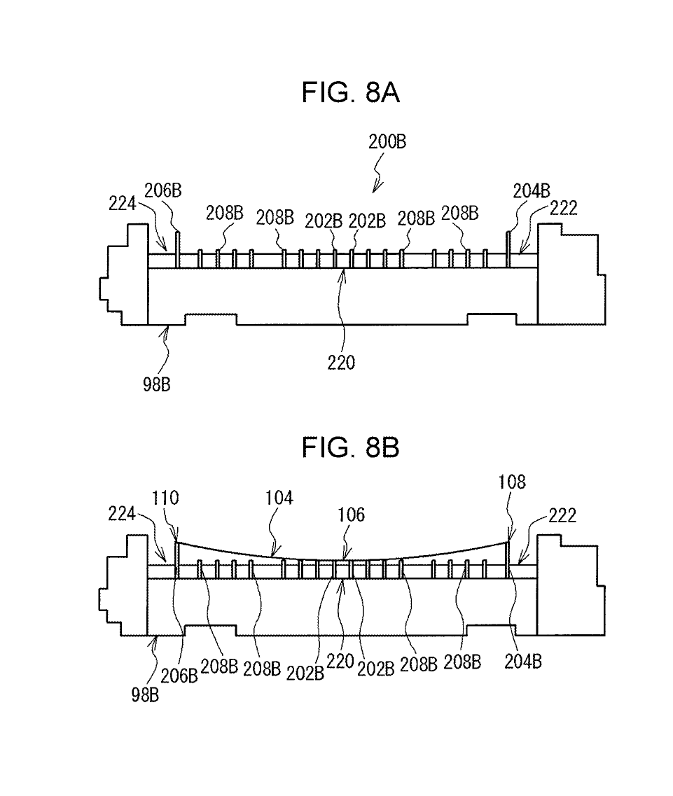

The guide portions 200 according to the first exemplary embodiment are formed so that the amount of projection thereof decreases from the guide portions 204 and 206 near both ends 222 and 224 toward the guide portions 202 near the center 220. In contrast, as illustrated in FIGS. 7, 8A, and 8B, guide portions 200B according to a second exemplary embodiment are formed so that only guide portions 204B and 206B near both ends 222 and 224 have an amount of projection larger than those of guide portions 202B near the center 220 and other guide portions 208B. Components that are the same as those in the first exemplary embodiment are denoted by the same reference numerals, and detailed description thereof is thus omitted.

As illustrated in FIGS. 7, 8A, and 8B, the guide portions 200B on an exit unit 98B according to the second exemplary embodiment are formed so that the amount of projection of the guide portions 204B and 206B near both ends 222 and 224 is larger than those of the guide portions 202B near the center 220 and the other guide portions 208B. In other words, the amounts of projection of the guide portions 202B near the center 220 and the other guide portions 208B are smaller than that of the guide portions 204B and 206B near both ends 222 and 224. The guide portions 202B near the center 220 and the other guide portions 208B are formed so as to project by substantially the same amount to form a substantially flat shape, that is, so that the difference in the amount of projection between the guide portions 200B is small.

In this case, after the recording medium 104 is discharged from the fixing device 36, both end portions 108 and 110 of the recording medium 104 in the direction crossing the transporting direction of the recording medium 104 come into contact with the guide portions 204 and 206 near both ends 222 and 224, which have an amount of projection larger than those of the guide portions 202 near the center 220 and the other guide portions 208B.

With this structure, the recording medium 104 discharged from the fixing device 36 in the curved state may be guided while both end portions 108 and 110 on both sides of the central portion 106 in the direction crossing the transporting direction are in contact with the guide portions 204 and 206 near both ends 222 and 224. Accordingly, the risk that only the central portion 106 of the recording medium 104 will receive a large contact force and that defects such as streaks will be formed on the image may be reduced.

### Third Exemplary Embodiment

To prevent the central portion 106 of the recording medium 104 discharged from the fixing device 36 in the curved state from receiving a high contact pressure from the guide portions, the guide portions may be formed so that only a guide portion 202C near the center 220 of an exit unit 98C has an amount of projection smaller than those of guide portions 204C and 206C near both ends 222 and 224 and other guide portions 208C.

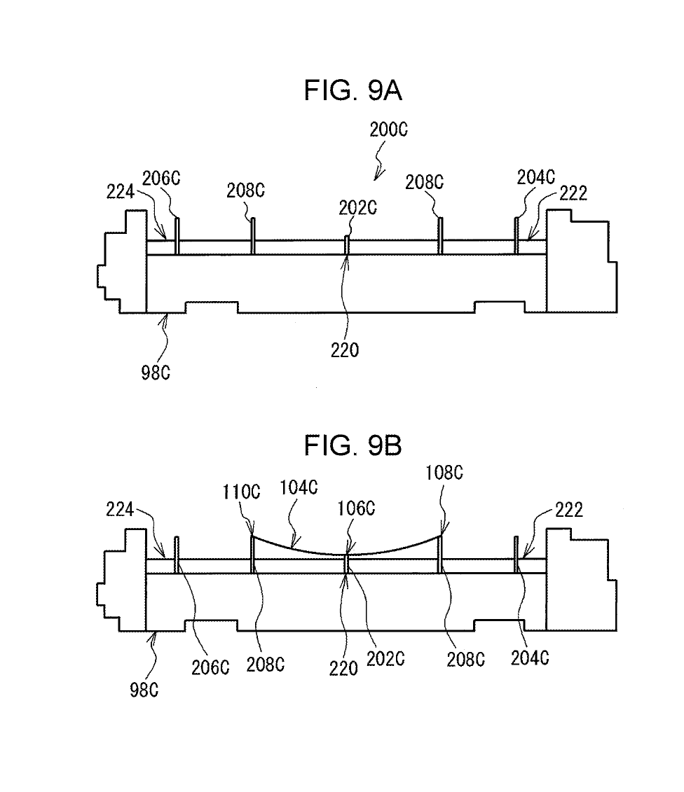

A third exemplary embodiment will now be described with reference to FIGS. 9A and 9B. In the third exemplary embodiment, the guide portion 202C near the center 220 of the exit unit 98C has an amount of projection smaller than those of the guide portions 204C and 206C near both ends 222 and 224 and the other guide portions 208C. Components that are the same as those in the first exemplary embodiment are denoted by the same reference numerals, and detailed description thereof is thus omitted.

As illustrated in FIG. 9A, guide portions 200C according to the third exemplary embodiment are formed so that the guide portion 202C near the center 220 of the exit unit 98C has an amount of projection smaller than those of the guide portions 204C and 206C near both ends 222 and 224 and the other guide portions 208C. The guide portion 202C that is closest to the center 220 has an amount of projection smaller than that of one of the other guide portions 208C that is closest to the guide portion 202C near the center 220 in the direction crossing the transporting direction.

With the above-described structure, as illustrated in FIG. 9B, even when, for example, a recording medium 104C having a small width is transported, a central portion 106C of the recording medium 104C comes into contact with the guide portion 202C near the center 220, and both end portions 108C and 110C of the recording medium 104C come into contact with the guide portions 208C having an amount of projection larger than that of the guide portion 202C near the center 220. Accordingly, the risk that only the central portion 106C of the recording medium 104 will receive a large contact pressure and that image defects will be formed may be reduced.

In each of the first and second exemplary embodiments, a total of eighteen guide portions 200, 200B are provided. In the third exemplary embodiment, a total of five guide portions 200C are provided. However, the number of guide portions is not limited to this, and a total of at least three guide portions may be provided, the three guide portions including guide portions near both ends of the exit unit and a guide portion that is near the center and that has an amount of projection smaller than that of the guide portions near both ends. Furthermore, four or more guide portions may be provided as long as guide portions near both ends of the exit unit have an amount of projection larger than those of other guide portions, that is, as long as guide portions near the center has an amount of projection smaller than those of other guide portions.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An image forming apparatus comprising:
a fixing device including a pressing unit and a heating unit that opposes the pressing unit; and
a plurality of guide portions disposed downstream of the fixing device and arranged in a direction crossing a transporting direction of a recording medium,
wherein an amount of projection of the guide portions is smaller in a region near a center of the fixing device than in a region near an end of the fixing device,
wherein the guide portions are disposed to face a surface of the recording medium discharged from the fixing device, the surface having an image formed thereon.

2. The image forming apparatus according to claim 1, wherein a height of the guide portions decreases with increasing distance in a direction from the end toward the center.

3. The image forming apparatus according to claim 2, wherein the height of the guide portions decreases substantially along a curve with increasing distance in the direction from the end toward the center.

4. The image forming apparatus according to claim 1, wherein at least one of the guide portions along which an end portion of the recording medium in the direction crossing the transporting direction passes has an amount of projection larger than an amount of projection of other guide portions.

5. The image forming apparatus according to claim 1, wherein one of the guide portions that is closest to the center has an amount of projection smaller than an amount of projection of another one of the guide portions that is closest to the one of the guide portions in the direction crossing the transporting direction.

6. The image forming apparatus according to claim 1, wherein a difference in the amount of projection between the region near the end and the region near the center is smaller in a downstream region of the guide portions in the transporting direction of the recording medium than in an upstream region of the guide portions in the transporting direction of the recording medium.

7. The image forming apparatus according to claim 6, wherein the difference in the amount of projection between the region near the end and the region near the center decreases with increasing distance from the upstream region toward the downstream region of the guide portions in the transporting direction of the recording medium.

8. The image forming apparatus according to claim 1, wherein a discharge unit to which the recording medium that has been transported is discharged is provided downstream of the fixing device, and
wherein the guide portions are disposed between the fixing device and the discharge unit.

9. (canceled)

10. The image forming apparatus according to claim 1, wherein the guide portions comprise center guide portions in the region near the center, edge guide portions in the region near the end of the fixing device and intermediate guide portions between the center guide portions and the edge guide portions,
wherein an amount of projection of the intermediate guide portions is larger than the center guide portions and smaller than the edge guide portions.

11. The image forming apparatus according to claim 6, wherein the difference in the amount of projection between the region near the end and the region near the center decreases with increasing distance from the upstream region toward the downstream region of the guide portions in the transporting direction of the recording medium, and the amount of projection of the guide portions in a region near the center of the fixing device is substantially the same as the amount of projection of the guide portions in a region near the end of the fixing device in the downstream region of the guide portions in the transporting direction of the recording medium.
